(19) United States
(12) Patent Application Publication
(10) Pub. No.: US 2026/0066653 A1
(43) Pub. Date: Mar. 5, 2026

(54) ENERGY MANAGEMENT SYSTEM

(71) Applicant: NISSAN NORTH AMERICA, INC., Franklin, TN (US)

(72) Inventors: Anna BARANSKAYA, Oakland, CA (US); Geoffrey Andrew PETTET, Oakland, CA (US); Lance Lawton ATKINS, Carmichael, CA (US); Shannon Bree ANDERSON, Smyrna, TN (US)

(21) Appl. No.: 18/821,729

(22) Filed: Aug. 30, 2024

(51) Int. Cl. H02J 3/00; B60L 53/63; B60L 55/00

(52) U.S. Cl. CPC H02J 3/003; B60L 53/63; B60L 55/00; H02J 3/008; H02J 2103/35; H02J 2105/12; H02J 2105/52; H02J 2105/57

(57) ABSTRACT

An energy management system includes a plurality of electrical consumers, an asset aggregator. The plurality of electrical consumers is configured to consume electrical power supplied by an electrical power grid. The plurality of electrical consumers is within a geographical region. The asset aggregator is configured to control the supply of electrical power to the plurality of electrical consumers in the geographical region and to control the supply of electrical power from each of the plurality of electrical consumers to the electrical power grid. The supply of electrical power from each of the plurality of electrical consumers being based on a predicted demand.

### BACKGROUND

### Technical Field

The present disclosure generally relates to an energy management system. More specifically, the present disclosure relates to an energy management system in which an electrical power grid communicates with an electric vehicle to facilitate maintaining stability of the electrical power grid.

### Background Information

As renewable energy sources, such as solar and wind power, continue to expand, ensuring stability of the electrical power grid has become increasingly vital.

Unlike traditional fossil fuel-based generation, renewable energy generation is often intermittent and unpredictable, fluctuating with factors, such as weather patterns and a time of day. This variability introduces challenges for grid operators in maintaining a stable balance between electricity supply and demand. Without adequate measures to manage this variability, electrical power grid instability can lead to power outages, voltage fluctuations, and other reliability issues.

The growth of electrification, including charging of electric vehicles, poses more pressure on an already fragile electrical power grid. The electrical power grid does not communicate or otherwise interact with electric vehicles to ensure beneficial behavior thereof for stability of the electrical power grid. Utilities can communicate with electrical consumers to request that the electrical consumers behave in a desired manner, such as pausing electrical charging of an electric vehicle at a particular time of day. However, such communications do not consider the needs of the electrical consumer.

### SUMMARY

A need exists for an improved electrical grid infrastructure in which an electrical power grid communicates with an electrical vehicle to facilitate maintaining stability of the electrical power grid.

In view of the state of the known technology, one aspect of the present disclosure is to provide an energy management system including a plurality of electrical consumers, and an asset aggregator. The plurality of electrical consumers is configured to consume electrical power supplied by an electrical power grid. The plurality of electrical consumers is within a geographical region. The asset aggregator is configured to control the supply of electrical power to the plurality of electrical consumers in the geographical region and to control the supply of electrical power from each of the plurality of electrical consumers to the electrical power grid. The supply of electrical power from each of the plurality of electrical consumers being based on a predicted demand.

Also other objects, features, aspects and advantages of the disclosed energy management system will become apparent to those skilled in the art from the following detailed description, which, taken in conjunction with the annexed drawings, discloses exemplary embodiments of an energy management system.

### BRIEF DESCRIPTION OF THE DRAWINGS

Referring now to the attached drawings which form a part of this original disclosure:

FIG. 1 is a schematic illustration of an energy management system of an electrical grid system in accordance with an exemplary embodiment;

FIG. 2 is a schematic illustration of communication within the energy management system of FIG. 1;

FIG. 3 is a schematic illustration of an electrical customer of FIG. 1;

FIG. 4 is a schematic illustration of the energy management system during a first forecasted event;

FIG. 5 is a schematic illustration of the energy management system during a second forecasted event;

FIG. 6 is a schematic illustration of a coordination service of the energy management system communicating with electrical consumers;

FIG. 7 is a schematic illustration of preparing a bid during a bid process in the energy management system of FIG. 1;

FIG. 8 is a schematic illustration of a bid acceptance during the bid process in the energy management system of FIG. 1;

FIG. 9 is a schematic illustration of the energy management system during a forecasted event following a bid acceptance during the bid process; and

FIG. 10 is a schematic illustration of electrical usage optimization in the energy management system of FIG. 1.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

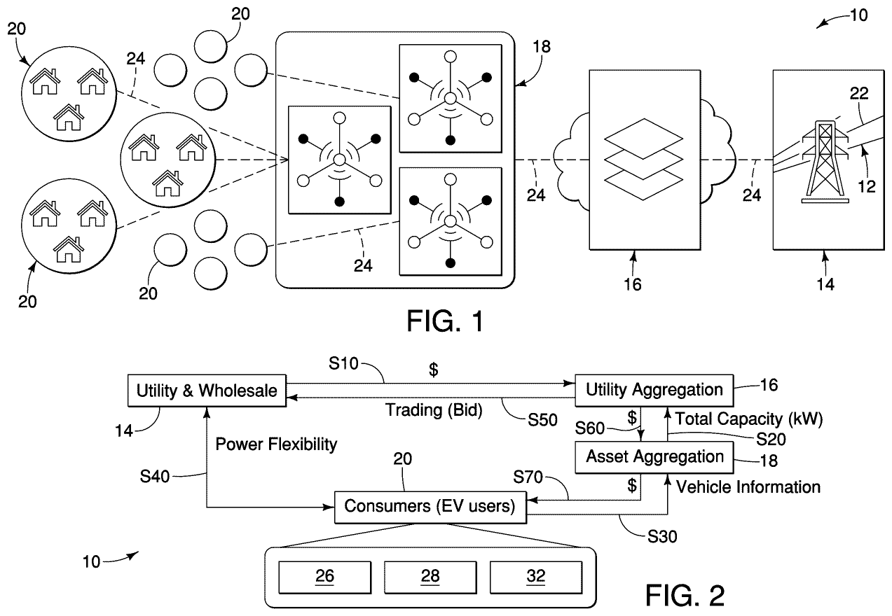

Referring initially to FIGS. 1 and 2, an energy management system 10 includes an electrical power grid 12, a utility wholesaler 14, a utility aggregator 16, an asset aggregator 18, and a plurality of electrical consumers 20. Each of the utility wholesaler 14, the utility aggregator 16, and the asset aggregator 18 includes an electronic controller configured to operate as described herein.

Generated electricity is transmitted through high-powered transmission lines 22 to the utility wholesaler 14, as shown in FIG. 1. The utility wholesaler 14 manages distribution of electricity over a transmission network 24. The utility wholesaler 14 maintains a balance between the power supply from the electrical power grid 12 and the demand from the plurality of electrical consumers 20. The utility wholesaler 14 is configured to control a supply of electrical power to the utility aggregator 16. The utility aggregator 16 serves as a virtual power plant (VPP) that integrates multiple power sources to provide grid power. The asset aggregator 16, or the VPP, can aggregate a plurality of distributed energy resources (DER). The DER can include wind power plants, electrical vehicle batteries, and other electrical storage.

The utility aggregator 16 facilitates management of the supply and demand of the electrical power grid 12 by the utility wholesaler 14, as shown in FIGS. 1 and 2. The utility aggregator 16 communicates between the utility wholesaler 14 and the asset aggregator 18. The utility aggregator 16 is configured to control a supply of electrical power to the asset aggregator 18.

The asset aggregator 18 communicates between the utility aggregator 16 and each of the plurality of electrical consumers 20 in a geographical region, as shown in FIGS. 1 and 2. The utility aggregator 18 is configured to communicate with a plurality of asset aggregators 18 in which each asset aggregator 18 is configured to communicate with a plurality of electrical consumers 20. Each asset aggregator 18 communicates with a plurality of electrical consumers 20 in a different geographical region. In other words, a first plurality of electrical consumers 20 in a first geographical region communicate with a first asset aggregator 18, and a second plurality of electrical consumers 20 in a second geographical region communicate with a second asset aggregator 18.

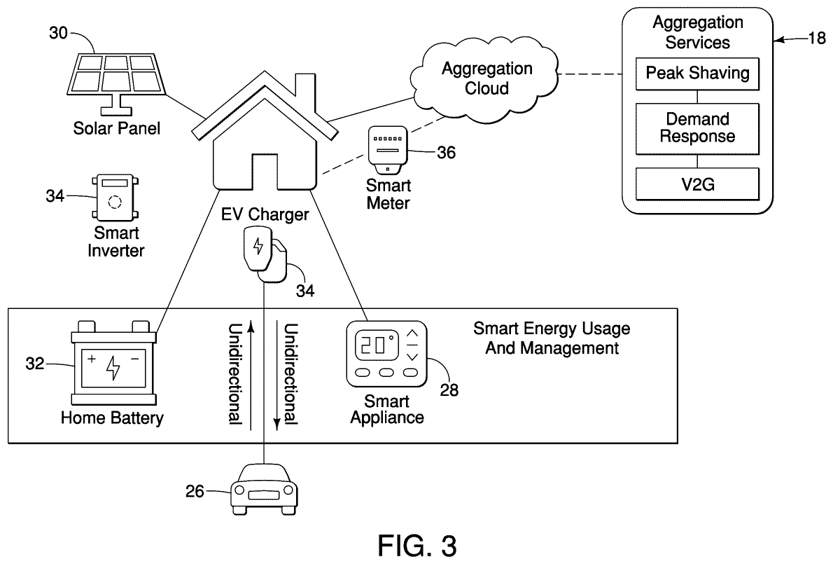

The plurality of electrical consumers 20 is configured to consume electrical power supplied by the electrical power grid 12 and to supply electrical power to the electrical power grid 12, as shown in FIGS. 1 and 3. The plurality of electrical consumers 20 have a plurality of electrical assets, as shown in FIG. 3, including, but not limited to, an electric vehicle (EV) 26, a smart appliance 28, a solar panel 30, and electrical storage 32.

The solar panel 30 generates electricity, such as for the residence of the electrical consumer 20, as shown in FIG. 3. A smart inverter 34 can convert the generated direct current (DC) electricity to alternating current (AC) electricity that can be stored in the storage 32, such as a battery. The electrical power grid 12 uses AC electricity.

The residence of the consumer 20 can include an EV charger 34, as shown in FIG. 3. The EV charger 34 charges a battery of the EV connected to the charger with power supplied from the electrical power grid 12. Alternatively, electrical power can be transmitted from the EV 26 to the electrical power grid 12. In other words, the EV 26 is configured for bi-directional charging. Vehicle-to-grid (V2G) technology provides electrical power to be supplied to the EV 26, and provides electrical power to be discharged from the EV 26 to the electrical power grid 12. The EV 26 is configured for a V2X system, such as V2G, V2H (vehicle-to-home), V2B (vehicle-to-building), and V2L (vehicle-to-load) systems. The electric vehicle 26 is configured to receive electrical power, and is also configured to discharge electrical power to the electrical power grid 12, or other destination, to balance variations in electrical production and consumption.

The smart appliance 28 includes, but is not limited to, a smart thermostat, smart sockets, smart water heater, and smart kitchen appliances. The residence of the consumer 20 can include a smart meter 36 configured to facilitate aggregation services.

Electricity aggregation begins by coordinating different smart electrical devices or assets, such as the electric vehicle 26 or other smart appliance 28, with a home, as shown in FIGS. 1 and 3. These energy assets, at scale, can impact the electrical power grid 12. The smart meter 36 can communicate information with the asset aggregator 18. The asset aggregator 18 combines the energy assets from the plurality of electrical consumers into the DER. The utility aggregator 18 can include a plurality of utility aggregators in which each utility aggregator manages a different type of smart asset. In other words, one asset aggregator 18 manages power from home solar panels 30, and another asset aggregator 18 manages power from the electric vehicles 26. The energy assets are bundled together to serve as the virtual power plant, which can act responsive to grid demand.

The asset aggregator 18 optimizes assets in a particular region, or sublap, and controls the schedule of the assets to deliver the requested energy. A sublap is a geographic location of the electrical consumer 20 within a distribution network of the asset aggregator 18.

The utility aggregator 16 coordinates the plurality of asset aggregators 18 to function together as the virtual power plant. The utility aggregator 16, also known as a distributed energy resource management system (DERMS), manages demand in two ways, i.e., a demand response and a supply-side response. The demand response lowers and shifts demand to smooth grid loads. The supply-side response balances and matches renewable energy production to meet demand. The utility aggregator 16 analyzes, forecasts and optimizes the energy supply and demand in the virtual power plant, and then delivers or curtails energy to and from the electrical power grid 12 accordingly.

In the energy management system 10 of FIGS. 1 and 2, the wholesaler 14 sets the wholesale price for electricity and communicates the price to the utility aggregator 16, as shown in FIG. 1 and step S10 of FIG. 2. The wholesaler 14 communicates forecasted and current grid needs to the utility aggregator 16, as shown in FIGS. 1 and 2. The utility aggregator 16 then analyzes the demand to determine how to fulfill the needs of the wholesaler 14.

The utility aggregator 16 communicates an electrical demand to the asset aggregator 18, as shown in FIGS. 1 and 2, regarding a needed capacity from the electrical assets under control of the asset aggregator 18. The asset aggregator 18 then communicates a current capacity of the electrical assets to the utility aggregator 16, as shown in step S20 of FIG. 2.

The electrical consumer 20 communicates an electrical demand to the asset aggregator 16, as shown in FIGS. 1 and 2. The asset aggregator 18 can directly control electrical assets of the electrical consumer 20, such as the electric vehicle 26 and the smart appliance 28. Information, such as vehicle information, regarding a current capacity is transmitted from the electrical consumer 20 to the asset aggregator 18, as shown in step S30 of FIG. 2. As shown in step S40 of FIG. 2, electrical power is supplied directly between the wholesaler 14 and the plurality of electrical consumers 20.

As shown in step S50 of FIG. 2, the utility aggregator 16 submits a bid for electrical power to the wholesaler 14. The bid is based on forecasted and current grid needs. As shown in step S10 of FIG. 2, the wholesaler sells electricity to the utility aggregator 16. In step S60 of FIG. 2, the utility aggregator 16 sells electricity to the asset aggregator 18. The asset aggregator 18 then sells electricity to the electrical consumer 20, in step S70 of FIG. 2. As shown in step S40 of FIG. 2, the electricity is directly supplied between the wholesaler 14 and the electrical consumer 20. Electricity can also be sold from the utility aggregator 16 to the wholesaler 14 to meet heightened demands.

In a demand-response program, a goal is to reduce energy demand, such as from EV's, during a predetermined time period. A predetermined number of demand-reduction events ranging for a predetermined timer period, such as one to four hours, can be periodically scheduled. For example, a predetermined number of events can be scheduled between May 1^{st} to September 30^{th} during which demand on the electrical power grid is heightened. Prior to the scheduled event, the asset aggregator 18 directly communicates with the electrical consumer 20 to determine whether the electrical consumer wants to participate in the scheduled event. The asset aggregator 18 can provide a financial incentive to the electrical consumer 20 to participate in the event. Alternatively, the electrical consumer 20 can opt out of participating in the scheduled event. The utility aggregator 16 forecasts the energy demand for the time period of the scheduled event. The utility aggregator 16 determines EV charging levels for the time period of the scheduled event. The utility aggregator 16 transmits a signal regarding the EV charging levels to the asset aggregator 18. The asset aggregator 18 directly controls the EV charging levels based on the transmitted signal from the utility aggregator 16 for each electrical consumer 20 participating in the scheduled event.

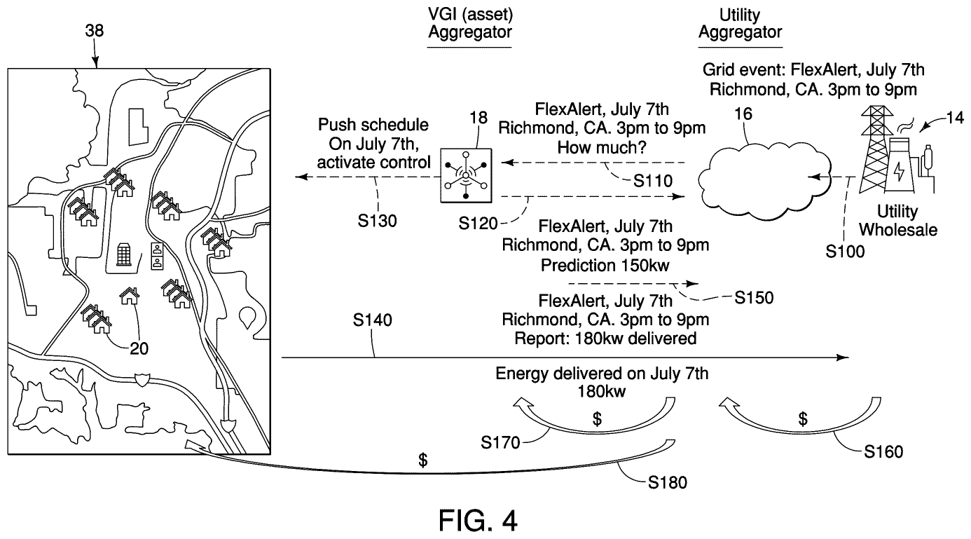

An example of a scheduled, or forecasted, event in a demand-response program in a first geographic region, or first sublap, 38 controlled by the asset aggregator 18 is illustrated in FIG. 4. The wholesaler 14 determines a scheduled event for July 7 for the city of Richmond, California, and transmits the scheduled event to the utility aggregator in step S100. In other words, the utility wholesaler 14 communicates the forecasted event to the utility aggregator 16. The forecasted event is a time period during which the supply of electrical power from the electrical power grid is reduced.

The utility aggregator 16 transmits a request to the asset aggregator 18 regarding an estimate as to how much electrical power is demanded between 3 pm and 9 am on July 7-8 in step S110. The asset aggregator 18 transmits a communication to the utility aggregator 16 estimating 150 kW of electrical power can be supplied during the scheduled event in step S120. The asset aggregator 18 controls each of the electrical assets of the plurality of electrical consumers 20 in the first geographical region 38 during the scheduled event such that the estimated electrical power to be supplied is met in step S130, thereby reallocating the electrical energy of the electrical power grid 12.

During the scheduled event, the electrical consumers 20 in the geographic region of the asset aggregator 18, deliver 180 kW of electrical power to the electrical power grid in step S140. During the scheduled event, the asset aggregator 18 is configured to cause the electric vehicle 26 to stop charging when the electric vehicle 26 is currently in a charging operation to reduce the demand for electrical power. The asset aggregator 18 is further configured to cause the electric vehicle 26 to resume the charging operation upon termination of the forecasted event. During the scheduled event, the asset aggregator 18 is configured to cause the electric vehicle 26 to supply power to a commercial building or a residential house to which the electric vehicle 26 is electrically connected. The asset aggregator 18 is further configured to cause the commercial building or residential house to transmit electrical power to the electric vehicle upon termination of the forecasted event. During the forecasted event, the asse aggregator 18 is configured to cause the electric vehicle 26 to supply power to the electrical power grid 12 to which the electric vehicle 26 is electrically connected. The asset aggregator 18 is further configured to cause the electrical power grid 12 to transmit electrical power to the electric vehicle 26 upon termination of the forecasted event.

After the scheduled event, the asset aggregator 16 transmits a report to the utility aggregator 16 including the electrical power transmitted to the electrical power grid through the wholesaler 14 in step S150. The cost for the electrical power delivered to the wholesaler 14 during the scheduled event is transmitted from the wholesaler 14 to the utility aggregator 16 in step S160. Revenues for the electrical power supplied during the scheduled event is transmitted to the asset aggregator 18 from the utility aggregator 16 in step S170. Financial incentives or reduction in electrical costs is transmitted from the asset aggregator 18 to each of the electrical consumers 20 in the first geographical region 38 based on the power supplied from the electrical assets of each electrical consumer 20 in step S180. In other words, the asset aggregator 18 is configured to reduce the supply of electrical power to the plurality of electrical consumers 20 during the forecasted event.

The utility aggregator 16 includes a request for a predicted electrical power demand to the asset aggregator 18 upon notification of the forecasted event. The asset aggregator 18 communicates the predicted electrical power demand to the utility aggregator 16 responsive to the request. The asset aggregator 18 controls the supply of electrical power to the plurality of electrical consumers 20 based on the predicted electrical power demand to ensure the electrical power reduction during the forecasted event is met. Additionally, the asset aggregators 18 can control the electrical assets of the plurality of electrical consumers 20 to supply, or discharge, electrical power to the electrical power grid 12 to further facilitate meeting the electrical power reduction during the forecasted event.

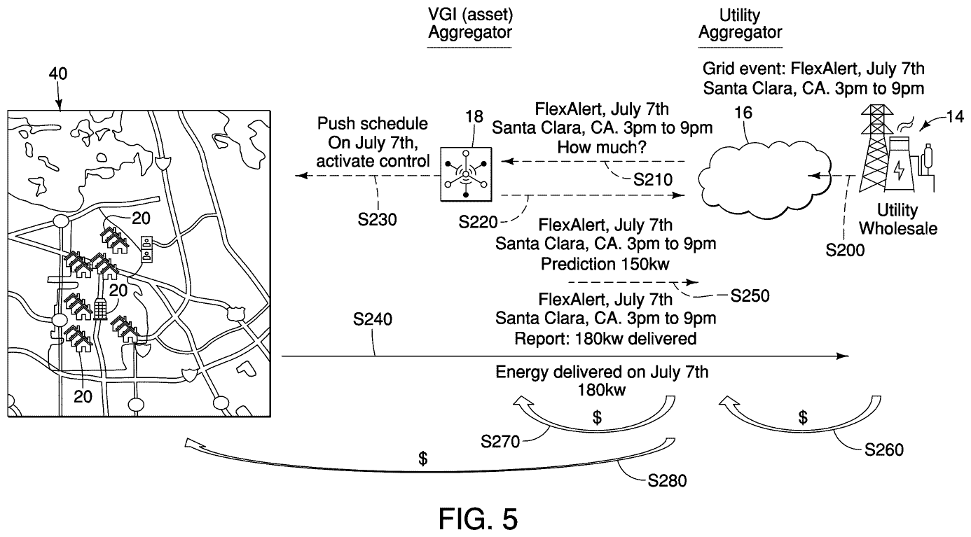

An example of a scheduled event in a demand-response program in a second geographic region, or second sublap, 40 controlled by the asset aggregator 18 is illustrated in FIG. 5. The wholesaler 14 determines a scheduled event for July 7 for the city of Santa Clara, California, and transmits the scheduled event to the utility aggregator in step S200. The utility aggregator 16 transmits a request to the asset aggregator 18 regarding as estimate as to how much electrical power can be supplied between 3 pm and 9 am on July 7-8 in step S210. The asset aggregator 18 transmits a communication to the utility aggregator 16 estimating 150 kW of electrical power can be supplied during the scheduled event in step S220. The asset aggregator 18 controls each of the electrical assets of the plurality of electrical consumers 20 in the second geographical region 40 during the scheduled event such that the estimated electrical power to be supplied is met in step S230, thereby reallocating the electrical energy of the electrical power grid 12. During the scheduled event, the electrical consumers 20 in the geographic region of the asset aggregator 18, deliver 180 kW of electrical power to the electrical power grid in step S240. After the scheduled event, the asset aggregator 16 transmits a report to the utility aggregator 16 including the electrical power transmitted to the electrical power grid through the wholesaler 14 in step S250. The cost for the electrical power delivered to the wholesaler 14 during the scheduled event is transmitted from the wholesaler 14 to the utility aggregator 16 in step S260. Revenues for the electrical power supplied during the scheduled event is transmitted to the asset aggregator 18 from the utility aggregator 16 in step S270. Financial incentives or reduction in electrical costs is transmitted from the asset aggregator 18 to each of the electrical consumers 20 in the second geographical region based on the power supplied from the electrical assets of each electrical consumer 20 in step S280.

In the scheduled events of the demand-response system illustrated in FIGS. 4 and 5, the plurality of electrical consumers 20, the asset aggregator 18 is configured to control the supply of electrical power to the plurality of electrical consumers 20 in the geographical region and to control the supply of electrical power from each of the plurality of electrical consumers 18 to the electrical power grid 12. The supply of electrical power from each of the plurality of electrical consumers 20 is based on a predicted demand transmitted from the asset aggregator 18 to the utility aggregator 16 in steps S120 and S220, respectively.

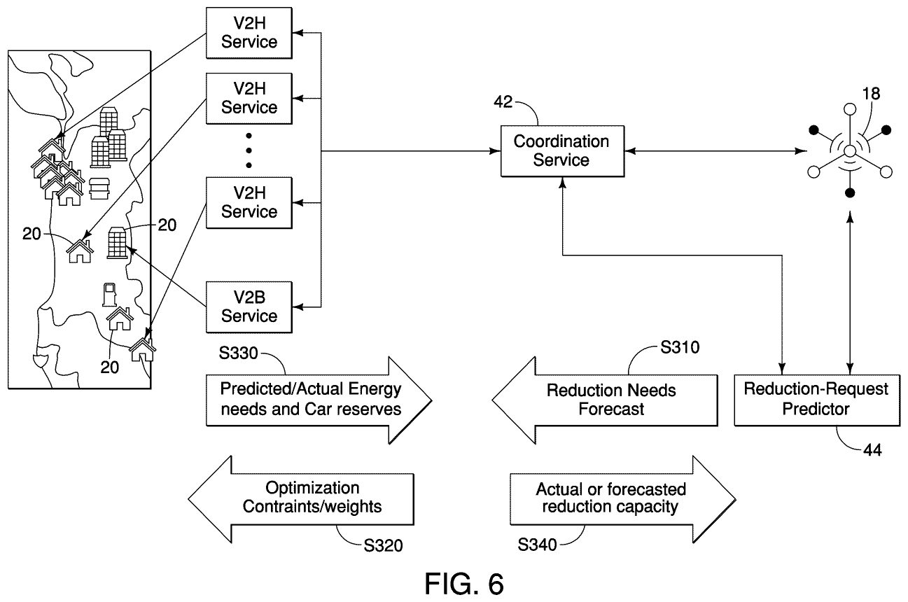

As shown in FIG. 6, a coordination service 42 is disposed between the asset aggregator 18 and each of the plurality of electrical consumers 20. The coordination service 42 includes an electronic controller configured to coordinate between the service needs of each electrical consumer 20 and asset aggregator 18. A prediction model 44 is disposed in communication with the coordination service 42 and the asset aggregator 18. The prediction model 44 facilitates predicting energy demands during a scheduled event in which a reduction in demand is requested (FIGS. 4 and 5). The prediction model 44 receives information from each of the electrical consumers 20 regarding driving behavior to facilitate predicting a future electrical demand of the electrical consumers 20.

During the scheduled event, the asset aggregator 18 transmits a request for a reduction needs forecast to the coordination service in step S310. The coordination service 42 transmits optimization constraints and weights to each of the plurality of electrical consumers 20 in step S320. The optimization is determined by the coordination service 42 in any suitable manner, such as by a rules-based algorithm, an integer linear programming (ILP) solver, an uncertainty-aware planner, or hierarchical planning. Each of the plurality of electrical consumers 20 transmits a predicted and/or actual energy needs and EV reserves to the coordination service 42 in step S330. The coordination service 42 aggregates the forecasts returned by the plurality of electrical consumers 20. The coordination service 42 transmits the actual or forecasted reduction capacity to the asset aggregator 18 in step S340.

The electrical consumers 20 can include an electrical asset, such as the EV 26, configured for V2X, or vehicle-to-everything, as shown in FIG. 6. V2X includes, but is not limited to, V2H, V2B and V2G. The EV charger 34 (FIG. 3) includes an electronic controller configured to communicate with the asset aggregator 18 to balance the electrical demand placed on the electrical power grid 12 by slowing or disabling EV charging during certain periods, such as during a peak demand period. During a peak demand period, the EV 26 can push stored electricity from the EV to either the home (V2H), a building (V2B), or to the electrical power grid (V2G) to supplement the available electrical power during a period of heightened demand. In other words, the electrical power of the EV's 26 is aggregated to reduce a variance in available energy.

The coordination service 42 coordinates between electrical power demands of the plurality of electrical consumers 20 and the demand reduction requests communicated to the asset aggregator 18, as shown in FIG. 6. The coordination service 42 is configured to forecast a future demand reduction needs of the asset aggregator 18 and the utility aggregator 16. The coordination service 42 is configured to forecast a demand reduction capacity based on a prediction of individual needs of the electrical consumers 20. The prediction model 44 is configured to predict the electrical needs of the plurality of electrical consumers 20. As shown in FIGS. 2, 4 and 5, the coordination service 42 is configured to make reduction commitment transactions with the asset aggregator 18 and the utility aggregator 16. The coordination service 42 is further configured to send control signals to each of the individual electrical consumers 20 responsive to the communicated reduction commitment transactions. The coordination service 42 is further configured to coordinate individual services for the electrical consumers 20 to be well positioned for future requests.

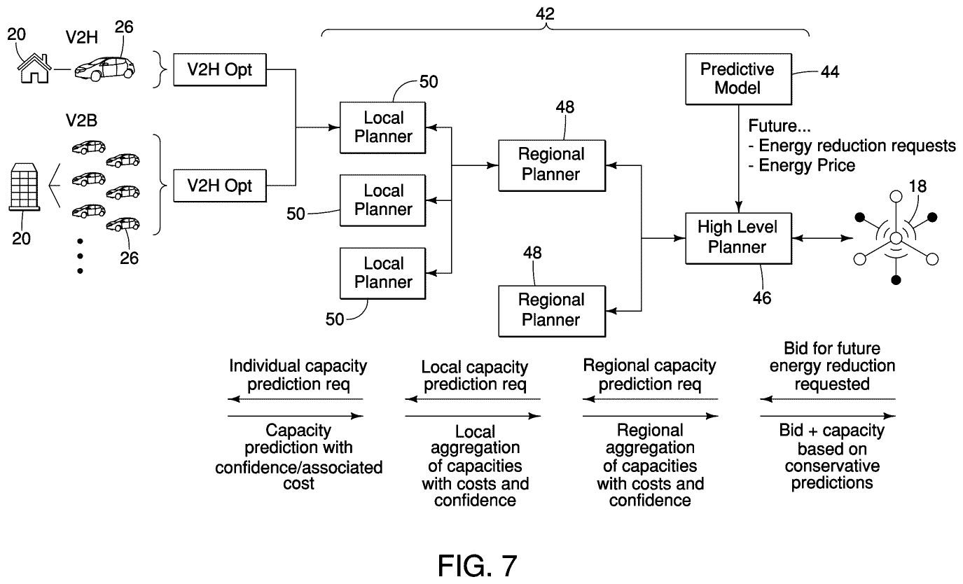

An exemplary bid process is illustrated in FIG. 7-9. The coordination service 42 includes the predictive model 44, a high level planner 46, a regional planner 48, and a local planner 50. Preferably, the coordination service 42 includes a plurality of local planners 50. Each of the local planners 50 is configured to control a sub-region of a geographical region, or sublap, such as a neighborhood. Preferably, the coordination service 42 includes a plurality of regional planners 48. Each of the regional planners 50 is configured to control a geographical region, or sublap. The high level planner 46 is configured to control the plurality of regional planners 48.

The bid process includes predictions and constraints. The predictions are transmitted upstream, i.e., from the plurality of electrical consumers 20 to the asset aggregator 18. The constraints are transmitted downstream, i.e., from the asset aggregator 18 to the plurality of electrical consumers 20.

As shown in FIG. 7, the asset aggregator 18 receives a request for a bid for future energy reduction from the utility aggregator 16, such as for a forecasted event illustrated in FIGS. 4 and 5. The asset aggregator 18 transmits the bid request to the high level planner 46 of the coordination service 42. The high level planner 46 transmits a request to each of the regional planners 48 for a prediction of electrical demand for the geographic region. Each of the regional planners 48 transmits a request to each of the local planners 50 for a prediction of electrical demand for the sub-region controlled by the local planner 50. Each of the local planners 50 transmits a request to each of the plurality of electrical consumers 20 controlled by the local planner 50 for a request for individual capacity.

Each of the electrical consumers 20 that opts into the future reduction request, transmits a capacity prediction to the respective local planner 50. Each of the local planners 50 aggregates the predicted capacities and transmits the local aggregation to the respective regional planner 48. Each of the regional planners 48 aggregates the predicted local capacities and transmits the regional aggregation to the high level planner 46. The high level planner 46 aggregates the regional capacities. The high level planner 46 transmits the aggregated regional capacities to the asset aggregator 18. The transmitted aggregated capacity includes a bid for electrical power during the future energy reduction event based on the predicted aggregated capacity. The prediction model 44 is configured to predict the electrical needs, or demand, of the plurality of electrical consumers 20. The prediction model 44 can base the predicted demand on a historic driving behavior for each of the plurality of EV's 26 of the electrical consumers 20. The prediction model 44 can transmit a predicted energy price based on a history of energy reduction requests to facilitate determining the bid by the high level planner 46.

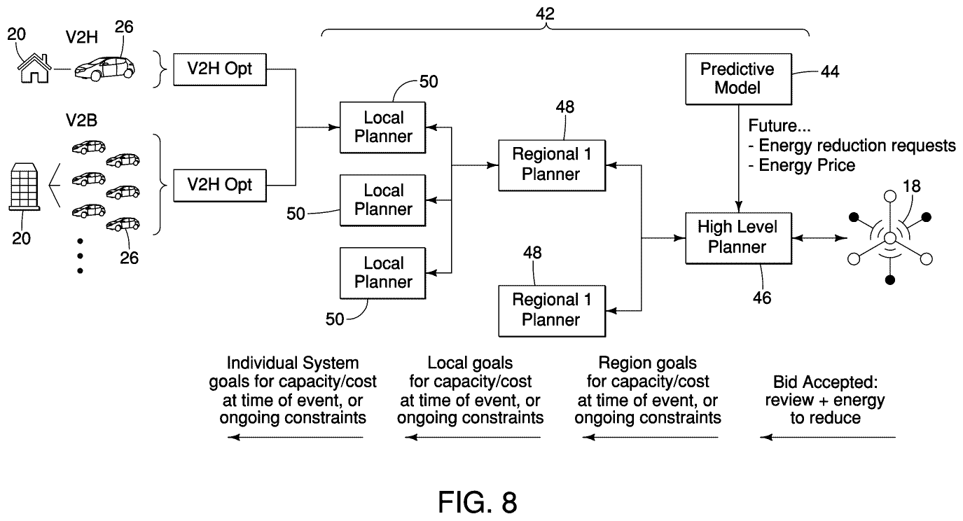

As shown in FIG. 8, the bid is accepted and integrated into the system for ongoing planning. The acceptance of the bid is transmitted by the asset aggregator 18 to the high level planner 46 of the coordination service 42. The high level planner 46 transmits goals for each of the regions controlled by the regional planners 48 at the time of the future energy reduction event. The goals include capacity for the region and electrical cost at the time of the event, as well as ongoing constraints to facilitate meeting the energy requirements at the time of the future energy reduction event.

Each of the regional planners 48 transmits goals for the sub-regions controlled by each of the local planners 50 at the time of the future energy reduction event, as shown in FIG. 8. The goals include capacity for the region and electrical cost at the time of the event, as well as ongoing constraints to facilitate meeting the energy requirements at the time of the future energy reduction event.

Each of the local planners 50 transmits goals for each of the plurality of electrical consumers 20 controlled by the respective local planners 50 at the time of the future energy reduction event, as shown in FIG. 8. The goals include capacity for the region and electrical cost at the time of the event, as well as ongoing constraints to facilitate meeting the energy requirements at the time of the future energy reduction event.

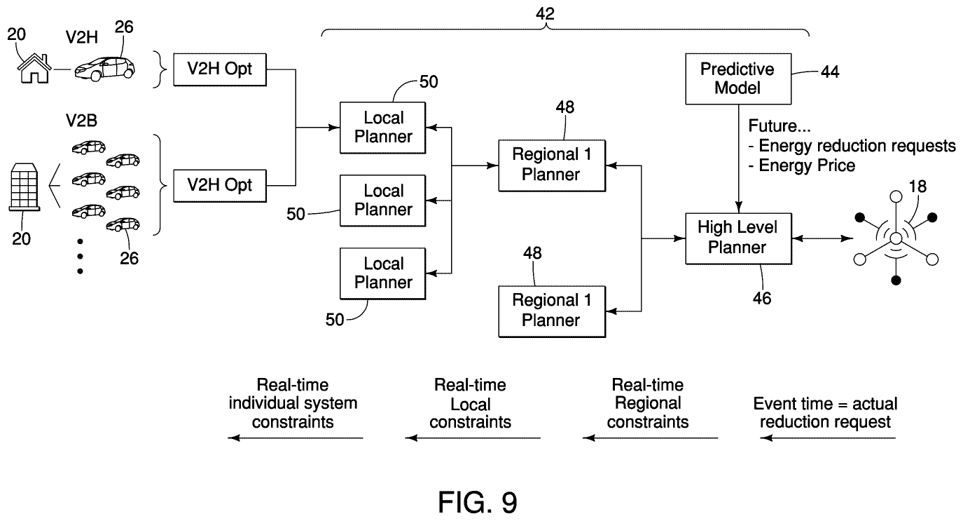

At the time of the future energy reduction event, as shown in FIG. 9, electrical constraints are transmitted downstream to ensure the predicted capacities are met. At the time of the future energy reduction event, the asset aggregator 18 transmits a request for energy demand reduction to the high level planner 46 of the coordination service 42. The high level planner 46 transmits constraints for each of the regions controlled by the high level planner 46 to each of the plurality of regional planners 48. Each of the regional planners 48 transmits constraints for each of the sub-regions controlled by the respective regional planners 48 to each of the local planners 50. Each of the local planners 50 controls the electrical assets, such as the EV's, of each of the electrical consumers 20 to meet the predicted electrical capacity. The local planners 50 can transmit a control signal to stop charging of an EV 26 during the energy reduction event, or control a smart thermostat to use less electricity. Additionally, the local planners 50 can cause the electrical assets, such as the EV's 26, to supply stored power back to the electrical power grid 12 to further facilitate meeting the predicted electrical capacity.

In the bid process illustrated in FIG. 7-9, the individual V2X (vehicle-to-everything) systems, such as the EV's 26, interact directly with the electrical consumers 20 and create specific energy forecasting models. These forecasts are filtered up the hierarchy of components in which each successive layer uses the predictions from its associated sub-planners (i.e., the regional planners 48 receive predictions from the local planners 50) to create a robust forecast of that region's energy capacity. The high level planner 50 estimates the energy capacity of the plurality of electrical consumers 20 (i.e., the energy capacity required by the electrical assets, or the V2X system). The energy capacity estimated by the high level planner 50 is used to bid with energy utilities, as shown in FIG. 7. Once a bid is accepted, as shown in FIGS. 8 and 9, control of the system flows in the opposite direction. The high level planner 50 generates energy curtailment constraints and pre-charging targets for each region, and then each subsequent layer determines how to split these targets among the respective sub-planners.

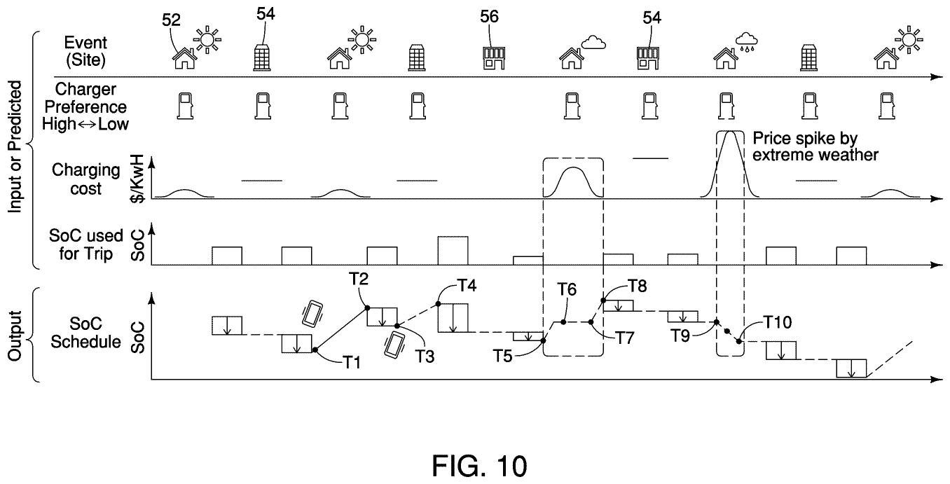

As shown in FIG. 10, an electrical consumer 20 drives an EV between a home residence 52, an office building 54, and a commercial store 56. At time T1, the local planner 50 of the coordination service 42 transmits a message to the electrical consumer recommending that the EV be plugged in and charged to maintain a higher state-of-charge for future energy reduction demand events. The electrical consumer charges the EV overnight at the home residence 52 to increase the state-of-charge of the EV between times T1 and T2.

At time T3, after driving from the home residence 52 to the office building 54, the local planner 50 transmits a message to the electrical consumer recommending that the EV be plugged in and charged to maintain a higher state-of-charge for future energy reduction demand events. The electrical consumer charges the EV while at the office building to increase the state-of-charge of the EV between times T3 and T4.

The electrical consumer drive the EV from the office building 54 to a commercial store 56 and then to the home residence 52 between times T4 and T5. At time T5, the state-of-charge of the EV is low, and the EV is plugged in to charge at time T5. At time T6, the charging cost is elevated, such that the local planner 50 sends a control signal to stop charging of the EV. In other words, the control applied by the asset aggregator 18 causes the electric vehicle 26 to stop charging when the electric vehicle 26 is currently in a charging operation. The EV is determined to have sufficient charge to drive from the home residence 52 to the office building 54, such that the local planner 50 can stop the charging of the EV without negatively impacting the electrical consumer. At time T7, the charging cost has decreased, such that the local planner 50 sends a control signal to resume charging of the EV. The charging of the EV is resumed at time T7 and resumes at time T8.

At time T8, the EV drives to a commercial store 54 and then returns to the home residence 52 at time T9. The EV is plugged in to charge at time T9. A price spike in electricity costs is generated due to extreme weather at time T9. The local planner 50 sends a control signal to the EV, which is plugged in at the home residence 52, to discharge electricity from the EV to electrical power grid 12 between times T9 and T10.

Revenue is generated by discharging electrical power to the electrical power grid during the price spike between times T9 and T10. In other words, the control applied by the asset aggregator 18 causes the electric vehicle 26 to supply power to the residential house 52 or to the commercial building 54 to which the electric vehicle is electrically connected. Alternatively, the control applied by the asset aggregator 18 causes the electric vehicle 26 to supply power to the electrical grid 12 to which the electric vehicle is electrically connected. A similar process is applicable to any electrical asset of each of the plurality of electrical consumers.

The V2X systems of the electrical consumers 20 work at the level of a single building. Aggregation takes place at the level of an entire service area of a utility aggregator 16 or wholesaler 14, which can include thousands of electrical consumers 20. The energy management system 10 uses decomposition, such as a hierarchical planning framework. EV's 26 tend to stay in or near their home region and electrical substations, which service the electrical consumer 20, require load balancing, such that a geographical decomposition is utilized in the energy management system 10.

The process illustrated in FIG. 10 is used with EV's that are available for energy purposes such that a lifestyle and/or behavioral change to the electrical consumer or stationary storage owners is not affected. For example, when the EV does not have a sufficient state-of charge, such as below 10%, the local planner will not stop charging of the EV or cause the EV to discharge electrical power to the electrical power grid. The energy management system integrates both EV's and stationary storage in residence homes, office buildings and commercial stores into a seamless system that is configured to interact with the electrical power grid and to do arbitrage between mobility needs, building loads, and other electrical power situations of the electrical power grid. The energy management system 10 ensures that the electrical consumer 20 has a seamless and cost-efficient charging and discharging experience regardless of the charging location (e.g., home residence 52, office building 54 or commercial store 56) without conflicting messages from the electrical power grid (e.g., wholesaler 14 or the utility aggregator 16). The energy management system 10 supports the electrical power grid 12 by utilizing the electrical assets (e.g., the EV 26 or storage 32) in the geographic region, or sublap, without impacting mobility of the electrical consumer 20.

Each of the electronic controllers of the energy management system 10 is a computer that includes one or more processors to execute the described functions of the respective components of the energy management system. As used herein, the terminology “processor” indicates one or more processors, such as one or more special purpose processors, one or more digital signal processors, one or more microprocessors, one or more controllers, one or more microcontrollers, one or more application processors, one or more Application Specific Integrated Circuits, one or more Application Specific Standard Products; one or more Field Programmable Gate Arrays, any other type or combination of integrated circuits, one or more state machines, or any combination thereof.

The processor can execute instructions transmitted by one or more transmission media, including coaxial cables, copper wire and fiber optics, including the wires that comprise a system bus coupled to a processor of a computer. As used herein, the terminology “instructions” may include directions or expressions for performing any method, or any portion or portions thereof, disclosed herein, and may be realized in hardware, software, or any combination thereof.

For example, instructions may be implemented as information, such as a computer program, stored in memory that may be executed by the processor to perform any of the respective methods, algorithms, aspects, or combinations thereof, as described herein. In some embodiments, instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

Computer-executable instructions can be compiled or interpreted from computer programs created using a variety of programming languages and/or technologies, including, without limitation, and either alone or in combination, Java™, C, C++, Visual Basic, Java Script, Perl, etc. In general, the processor receives instructions from a computer-readable medium and executes these instructions, thereby performing one or more processes, including one or more of the processes described herein. Such instructions and other data may be stored and transmitted using a variety of computer-readable media.

The controllers of the energy management system 10 are configured to communicate through a wired or wireless connection.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. The wireless communication signals can be radio frequency (RF) signals, ultra-wide band communication signals, or Bluetooth communications or any other type of signal suitable for wireless communication.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An energy management system comprising:
a plurality of electrical consumers configured to consume electrical power supplied by an electrical power grid, the plurality of electrical consumers being within a geographical region; and
an asset aggregator configured to control the supply of electrical power to the plurality of electrical consumers in the geographical region and to control the supply of electrical power from each of the plurality of electrical consumers to the electrical power grid,
the supply of electrical power from each of the plurality of electrical consumers being based on a predicted demand.

2. The energy management system according to claim 1, wherein
each of the plurality of electrical consumers includes an electric vehicle.

3. The energy management system according to claim 2, wherein
the predicted demand is based on a historic driving behavior for each of the electric vehicles.

4. The energy management system according to claim 3, wherein
the control applied by the asset aggregator causes the electric vehicle to stop charging when the electric vehicle is currently in a charging operation.

5. The energy management system according to claim 3, wherein
the control applied by the asset aggregator causes the electric vehicle to supply power to a commercial building or a residential house to which the electric vehicle is electrically connected.

6. The energy management system according to claim 3, wherein
the control applied by the asset aggregator causes the electric vehicle to supply power to the electrical power grid to which the electric vehicle is electrically connected.

7. The energy management system according to claim 3, wherein
a utility aggregator configured to control a supply of electrical power to the asset aggregator; and
a utility wholesaler configured to control a supply of electrical power to the utility aggregator.

8. The energy management system according to claim 7, wherein
the utility wholesaler communicates a forecasted event to the utility aggregator,
the forecasted event being a time period during which the supply of electrical power from the electrical power grid is reduced.

9. The energy management system according to claim 8, wherein
the asset aggregator reduces the supply of electrical power to the plurality of electrical consumers during the forecasted event.

10. The energy management system according to claim 9, wherein
the asset aggregator causes the electric vehicle to stop charging when the electric vehicle is currently in a charging operation.

11. The energy management system according to claim 9, wherein
the asset aggregator causes the electric vehicle to supply power to a commercial building or a residential house to which the electric vehicle is electrically connected during the forecasted event.

12. The energy management system according to claim 9, wherein
the asset aggregator causes the electric vehicle to supply power to electrical power grid to which the electric vehicle is electrically connected during the forecasted event.

13. The energy management system according to claim 10, wherein
the asset aggregator causes the electric vehicle to resume the charging operation upon termination of the forecasted event.

14. The energy management system according to claim 11, wherein
the asset aggregator causes the commercial building or the residential house to transmit electrical power to the electric vehicle upon termination of the forecasted event.

15. The energy management system according to claim 13, wherein
the asset aggregator causes the electrical power grid to transmit electrical power to the electric vehicle upon termination of the forecasted event.

16. The energy management system according to claim 7, wherein
a plurality of asset aggregators communicate with the utility aggregator.

17. The energy management system according to claim 16, wherein
a first plurality of electrical consumers communicate with a first asset aggregator, and
a second plurality of electrical consumers communicate with a second asset aggregator.

18. The energy management system according to claim 9, wherein
the utility aggregator transmits a request for a predicted electrical power demand to the asset aggregator upon notification of the forecasted event.

19. The energy management system according to claim 18, wherein
the asset aggregator communicates the predicted electrical power demand to the utility aggregator responsive to the request.

20. The energy management system according to claim 19, wherein
the asset aggregator controls the supply of electrical power to the plurality of electrical consumers based on the predicted electrical power demand.
